(19) United States
(12) Patent Application Publication
(10) Pub. No.: US 2016/0110363 A1
(43) Pub. Date: Apr. 21, 2016

(54) METHOD AND SYSTEM FOR MEASURING AND MATCHING INDIVIDUAL CULTURAL PREFERENCES AND FOR TARGETING OF CULTURE RELATED CONTENT AND ADVERTISING TO THE MOST RELEVANT AUDIENCE

(71) Applicants: Anatoliy TKACH, Atlantic Highlands, NJ (US); Yury ARANE, Brooklyn, NY (US)

(72) Inventors: Anatoliy TKACH, Atlantic Highlands, NJ (US); Yury ARANE, Brooklyn, NY (US)

(21) Appl. No.: 14/519,246

(22) Filed: Oct. 21, 2014

(51) Int. Cl. G06F 17/30; H04L 29/06

(52) U.S. Cl. CPC G06F 17/3053; H04L 65/403; G06F 17/30598

(57) ABSTRACT

A system and method for measuring individual cultural preferences and matching them with those of other individuals, and/or with culture related content. The system and method are designed to increase ROI in marketing, as well as to promote more frequent communications between internet users by: a) providing internet users with the ability to find their “peers”, i.e., people with the closest culture related preferences; b) delivering to internet users precisely targeted and highly relevant recommendations regarding culture related content and products, automatically generated based on selections made by the users' “peers”; c) defining the most appropriate target audience for a set of cultural content items; d) defining the most appropriate set of cultural content items for a user segment of a given social network; and e) increasing the exposure, and thus effectiveness, of advertisements by motivating internet users to establish new relationships with their “peers”.

### BACKGROUND

This disclosure generally relates to a method of identifying targets for and delivering cultural content and culture related advertising to the Internet users, and creating/composing content targeted for particular user groups.

Social networks like Facebook, Google+, Myspace, etc. and other forms of associations of Internet users like Amazon, YouTube, Yelp, etc. reach billions of people on a daily basis and provide convenient medium for electronic distribution of advertising and cultural content: product or service offers, music, books, movies, fine arts, etc. Companies engaged in creation and distribution of this content utilize various approaches to identify target audiences for their products. However, all of these approaches have something in common: they are based on artificial assumptions made by advertisers and content providers analyzing various sets of statistical data available within the social networks and other Internet communities about the users and their content/products choices, e.g. user profile info, demographic data, user purchases, likes, etc. Despite the fact that huge amount of data is analyzed and huge user audience is approached, these methods allow only a very rough definition of the target audiences for a particular content. Employing these methods keeps advertising budgets high, and at the same time bombards users with ads and content suggestions that hold very little relevance to them. Often it provokes large number of users to completely block all ads and content suggestions, making these users unreachable to advertisers and distributors.

On the other hand, many social networks and Internet communities facilitate exchange of product/content recommendations and suggestion among their users. Such suggestions and recommendations distributed to a select circle of user's <<friends>> and/or <<followers>> bear much more relevance to these persons as they come from people known to them or chosen by them. In this case, the recommending user knows the preferences of the targeted user, and feels responsible for a recommendation he/she gives. Obviously, it is the most precise and organic <<word-of-a-mouth>> approach to target the right consumer. However, a limitation here is a relatively low number of people personally known to one another. In addition, the speed and breadth of <<word-of-a-mouth>> info distribution fully depends on willingness of users to share their opinions and recommendations.

The present invention combines the strong points of both approaches. It harnesses the high relevance of peer group opinions and applies it to tremendously large use communities thus ensuring that each ad or cultural content item, presented to a potential consumer closely matches his/her interest and gets full attention which greatly increases a chance of a desired action by the consumer. In turn, increased “aiming” of ads and content offers leads to a high ROI of advertising and distribution efforts.

### SUMMARY

The present disclosure describes methods, models, systems, techniques, and apparatus intended to solve the following internet communication and marketing challenges:
1) Providing social network users with the ability to find their “peers”—people with the closest culture related preferences.
2) Delivering to the social network users precisely targeted and highly relevant recommendations regarding culture related content and products. These recommendations are generated automatically based on selections made by the user's “peers”.
3) Defining the most appropriate target audience for a particular set of cultural content items.
4) Defining the most appropriate set of cultural content items for a particular user segment of a given social network or a similar association of Internet users.
5) Increasing the exposure, and thus effectiveness, of advertisements by motivating users to establish new relationships with their “peers” in the social network.

As one of its material aspects, in order to provide marketing and communication solutions described above, this invention utilizes a mathematical model henceforth referred to as “Social Genome Model”. The term “Social Genome” illustrates one of the core purposes of the model such as to discover the users of the social network type internet communities such as Facebook, Google+, YouTube, Netflix, Spotify, etc. who share the most similar preferences regarding cultural content.

Social Genome Model provides the following processes to achieve the goals described above;
(a) Process for assigning to each individual social network user a precisely calculated identification value, which reflects the user's preferences with respect to classifiable (“taggable”) cultural content items such as books, music, movies, dance, ballet, theater, comedy, fine arts, etc.
(b) Process for identifying users within the given social network that have the most similar cultural preferences.
(c) Process of identifying users within the given social network who are the most relevant targets for advertising of a particular set of cultural content items or culture related products such as fashion, jewelry, accessories, cars, tourism, recreation, etc.
(d) Process of compiling the set of cultural content items or culture related products likely to match preferences of individual users or groups of users within a given social network.

These methods are applicable to a social network type associations of internet, users such as Facebook, Google+, Twitter, Myspace, YouTube, Netflix, Spotify, etc., where the users are able to persistently indicate their preferences regarding the culture related content.

The most critical attribute of a content item in this model is the fact that it is tagged. Tagging here means assigning to a content item one or more of well-known characteristics (tags). Tagging is extremely widely spread in the modem world—it covers almost all aspects of human, activities. Just about every industry has its own known set of tags for characterization of objects important to that particular industry. For example, in movies we can find genre (comedy, thriller, horror, etc.), in music there are styles (hip-hop, jazz, pop, rock, etc.), and so on. There are many organizations engaged in tagging different product and services—IMDB for movies, Warner Music and EMI for music. Penguin and Amazon for books, etc. However, it is important to understand that the most accurately tagged content is culture related. Accordingly, the Social Genome Model is specifically designed to operate on the culture related content items such as books, music, movies, dance, ballet, theater, comedy, fine arts, etc. it is also important to note that a full list of all tags for each cultural, content type is well-know and remains relatively stable over time. All tagging happens outside of Social Genome Model. Social Genome Model operates only on content items, which are already tagged in one way or another.

Social Genome Model considers a set of content items of a certain type (e.g. user's music library, electronic bookshelf, art collection, etc.) as criteria, which defines the user preference in the given type of content, (e.g. music, movies, books, art, etc.). Preference in Social Genome Model has a binary nature, i.e., if the person has expressed in some way a positive attitude towards a given content item, this item is considered a “preferred” item. Preference can be expressed in many different ways such as by “liking” or “sharing” an item on Facebook, by online purchase on Amazon, by “re-twitting” on Twitter, etc.

Social Genome Model operates on the tags assigned to each content item in the set. For example, each song in the user's music library has several tags assigned to it, e.g. rock, jazz, classical, country, etc., and these tags repeat across the list of songs in the library. Social Genome Model calculates the ratio of each tag across die set of content items denoted as a “Tag Ratio” (TR), namely the ratio of the total occurrences of the particular tag compared with the total occurrences of all tags.

Social Genome Model regards any set of content items of a certain type (e.g. music) as a point, denoted herein as “Content Point” (CP), in a multi-dimensional system of coordinates. The axes of this system of coordinates are the tags inherent to the given content type. The coordinate of the CP along a given axis is equal to a percent of occurrences of the corresponding tag within the set of content items, denoted herein as “Tag Ratio” (TR). See FIG. 1 for exemplary calculations.

Social Genome Model employs canonical mathematical function to calculate correlations, also referred to as distances, between CPs (ΔCPs) in the multi-dimensional system of coordinates. The resulting set of distances can be then analyzed from the point of view of relative proximity of CPs. Naturally, CPs located close to one another correspond to users having similar preferences and having greater affinity to one another than the users having CPs located at larger distances.

Correspondingly, these closely located users have better chance to match each other's expectations in real life communication, as shown below in the exemplary embodiment, see FIG. 3. Following the same logic, the choices, recommendations, suggestions of closely located users have more relevance to one another. Close users form a peer group that may be used to determine targets for advertising and distribution, as shown below in the exemplary embodiment, see FIG. 4.

Besides matching users' CPs, the Social Genome Model is also configured to be able to compare the CP value of a given set of content items (e.g. music collection) with existing CPs of the network users in order to target the given set of content to the most appropriate audience, see FIG. 5.

Social Genome Model also calculates an average point of all CPs in a given group of users. This point is denoted as “Centroid Content Point” (CCP), and is calculated using canonical definition of a centroid of a set of vectors. See FIG. 2 for example. CCP represents a virtual set of content items that has some affinity to most of the users in a given group. CCP can be used to compile a suitable content for a given audience, see FIG. 6.

In another of its material aspects, the present invention is a system. Including a server-side Internet software program hereinafter referred to as “Content Matching Engine” intended to achieve communication and marketing benefits described above in the first chapter of this Summary.

The Content Matching Engine presented in this invention can be used (without exclusion) in two basic embodiments:
(a) As a built-in content matching tool employed by the holders and administrators of existing social networks like Facebook and Google+, or within other associations of Internet users like Amazon, Netflix, Match.com, etc. Using this invention the social media holders can attract their respective users and advertisers with precisely targeted advertising and culture related content delivered to the most appropriate audience. The most important effect in this case is an increase of the user-to-user traffic across the users' universe, which improves the usability and profitability of pay-per-click and other transaction fee based advertising.
(b) As a supplemental built-in programmatic tool, employed by developers of web and mobile applications like Spotify, Pandora, Netflix, Google Play Store, Yelp, etc. Such applications deployed in the above-mentioned social media environments can utilized the present invention to greatly improve upon the existing content delivery methods, thus getting a competitive advantage.

### BRIEF DESCRIPTION OF THE DRAWINGS

For a more complete understanding of the present disclosure and its advantages, reference is made to the following descriptions, taken in conjunction with the accompanying drawings, in which:

FIG. 1 illustrates the use of Content Point (CP) approach for measuring and comparing the levels of similarity of content preferences for the social network users. Three Facebook users “liking” musical content are used in the depicted example.

FIG. 2 illustrates the use of Centroid Content Point (CCP) approach for determining the most appropriate content for a group of social network users. Three Facebook users “liking” musical content are used in the depicted example.

FIG. 3 illustrates the use of Content Matching Engine to discover “peers”—the people with similar cultural preferences—for the user of the dating website. The Match.com users with their connected Facebook profiles are used in the depicted example.

FIG. 4 illustrates the use of Content Matching Engine to exchange content recommendations/suggestions between social network users sharing the most common preferences regarding the given content type. The Facebook users and their music preferences are used in the depicted example.

FIG. 5 illustrates the use of Content Matching Engine for determining the most appropriate target audience segment, for a given set of content among all social network users within the given advertising budget. The Facebook users and their music preferences are used in the depicted example.

FIG. 6 illustrates the use of Content Matching Engine for compiling a set of content items most suitable for a given segment, of social network users. The Facebook users and their music preferences are used in the depicted example.

FIG. 7 illustrates how the exemplary Content Matching Engine promotes increase of traffic on social network by motivating users to create new unique connections between themselves. The Facebook users and their interrelations owing to the music content are used in the depicted example.

### DETAILED DESCRIPTION

The following detailed description refers to the accompanying drawings. Other embodiments of the present disclosure are possible and modifications may be made to the embodiments without departing from, the spirit and scope of the disclosure. Therefore, the following detailed description is not meant to limit the disclosure.

Moreover, for convenience in the ensuing description, some explanations of terms are provided herein. However, the explanations contained herein are intended to be exemplary only. They are not intended to limit the terms as they are described or referred to throughout the specification. Rather these explanations are meant to include any additional aspects and/or examples of the terms as described and claimed herein and/or as used by one of skill in the art.

In all exemplary embodiments described below, the Content Matching Engine is used as a part of music streaming software program installed on the Facebook server. It is designed and configured to work with the lists of music tracks. Music track is any digitized musical piece available on the Internet (song, concert receding, movie sound track, etc.) Facebook users make their preferences regarding music tacks by “liking” them thus including them in their personal music collections.

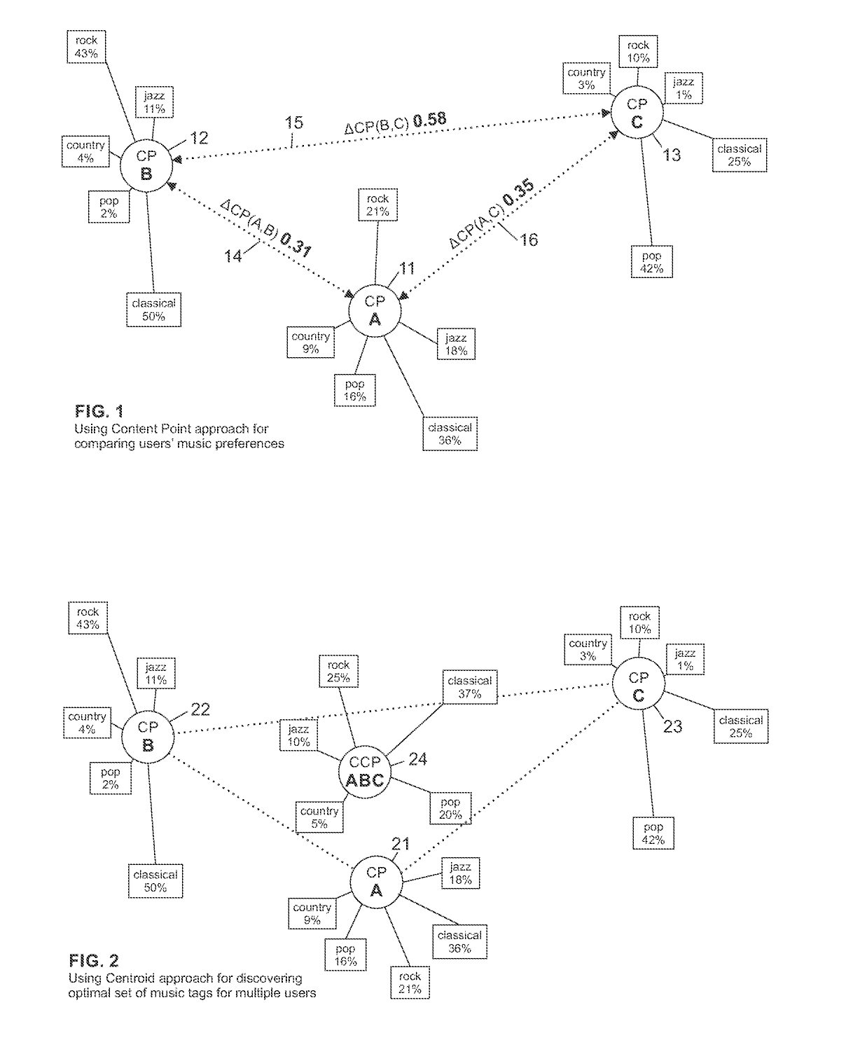

FIG. 1 presents three Facebook users A (11), B (12), and C (13), who “liked” three different sets of music. For this exemplary embodiment, let us assume that there are five popular tags currently used in the music industry: “rock”, “jazz”, “classical”, “pop”, and “country”.

For this exemplary embodiment Social Genome Model will precisely define the Content Points (CPs) for users A, B, and C, calculate correlations, also referred to as distances, between them (ΔCPs), and then compare the calculated ΔCPs in order to define who of these three users own the most similar music lists, and who of them own the most distant ones.

As used in the example shown on FIG. 1, user A “liked” 45 rock tracks, 40 jazz tracks, 80 classical tracks, 35 pop tracks, and 20 country tracks. Accordingly, the Tag Ratios (TRs) for the corresponding Tags for user A will calculated as follows:

TR1A(rock)will be 45/(45+40+80+35+20)=0.21

TR2A(jazz)will be 40/(50+40+80+35+20)=0.18

TR3A(classical)will be 80/(50+40+80+35+20)=0.36

TR4A(pop)will be 35/(50+40+80+35+20)=0.16

TR5A(country)will be 20/(50+40+80+35+20)=0.09

Users B and C own their respective sets of music. The CP of each user is represented as a point in a 5-dimensional system of coordinates, where the CP coordinates for axes “rock”, “jazz”, “classical”, “pop”, and “country” will be the TRs for the corresponding Tags.

FIG. 1 shows all three users A, B, and C with their corresponding CPs, as follows:

| | CP A | CP B | CP C |
|---|---|---|---|
| TR1, rock | 0.21 | 0.43 | 0.10 |
| TR2, jazz | 0.18 | 0.11 | 0.01 |
| TR3, classical | 0.36 | 0.50 | 0.25 |
| TR4, pop | 0.16 | 0.02 | 0.42 |
| TR5, country | 0.09 | 0.04 | 0.03 |

The Social Genome Model discovers content preference similarity for two individuals by calculating the distance ΔCP between their respective CPs. As described above, the CP is represented as a point in the multi-dimensional system of coordinates. The distance between two points A and B in a multi-dimensional system of coordinates is canonically defined as a square root of the sum of squares of the differences between the corresponding axes' coordinates for points A and B, as follows:

ΔCP(A,B)=SQRT(SUM((TR1A−TR1B)²+(TR2A−TR2B)²+ . . . +(TRnA−TRnB)²)))

As shown on FIG. 1, the ΔCPs for user pairs AB, AC and BC are marked accordingly as 14, 15, and 16. According to the formula above, the ΔCPs for these pairs of users will be calculated as follows:

ΔCP(A,B)=SQRT(SUM((0.21−0.43)²+(0.18−0.11)²+(0.36−0.50)²+(0.16−0.02)²+(0.09−0.04)²))=0.31(reference numeral 14)

Accordingly, the ΔCP(A,C)=0.35 (reference numeral 16), and the ΔCP(B,C)=0.58 (reference numeral 15).

The above calculation allows us to conclude that the users A and B “liked” the most similar sets of music out of three, and the users B and C “liked” the most distant ones. It is postulated that users with similar music lists share preferences and tastes in music. These users are likely to appreciate content choices made by other users with similar lists,

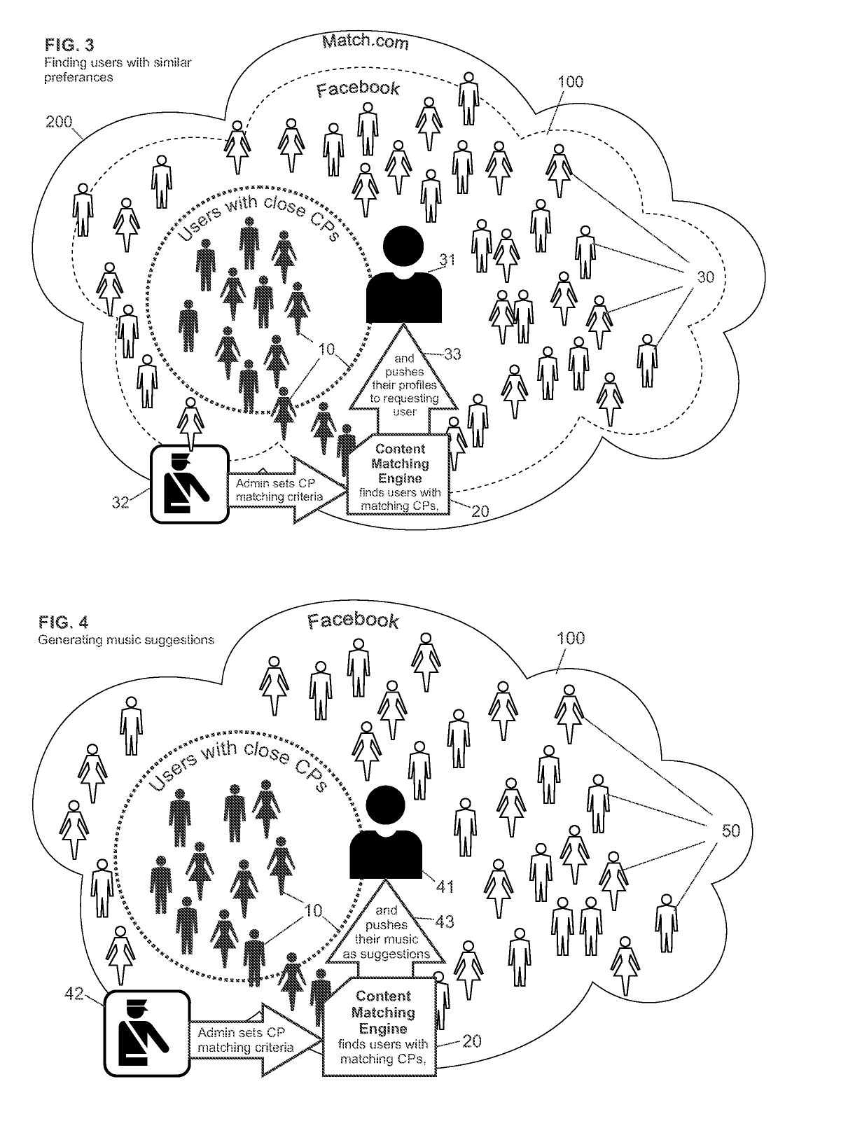

FIG. 2 illustrates the calculation of Centroid Content Point (CCP). For this exemplary embodiment, Social Genome Model will calculate a set of Tag Ratio values of a CCP (24) for a set of three Content Points (CPs): CP A (21), CP B (22) and CP C (23) representing Facebook users A (11), B (12), and C (13) previously mentioned in the description for FIG. 1. The Tag Ratios (TRs) for each CP are also shown.

Mathematically a Centroid for a set of points has the same meaning as an average value for a set on numbers. It is used to capture the commonality of their characteristics. Canonical formula for Centroid calculation in linear matrix notation is CCP=1/I Σᵢ^{J} εᵢ, where εⱼ=|x_{iJ} xᵢ₂ . . . xᵢⱼ . . . x_{iJ}| and I is a number of points.

In the current example, for CCP ABC (24), the point coordinates are calculated as follows:

TR1(rock)will be: (0.43+0.21+0.10)/3=0.247˜0.25

TR2(jazz)will be: (0.11+0.18+0.01)/3=0.10

TR3(classical)will be: (0.50+0.36+0.25)/3=0.37

TR4(pop)will be: (0.02+0.16+0.42)/3=0.20

TR5(country)will be(0.04+0.09+0.03)/3=0.053−0.05

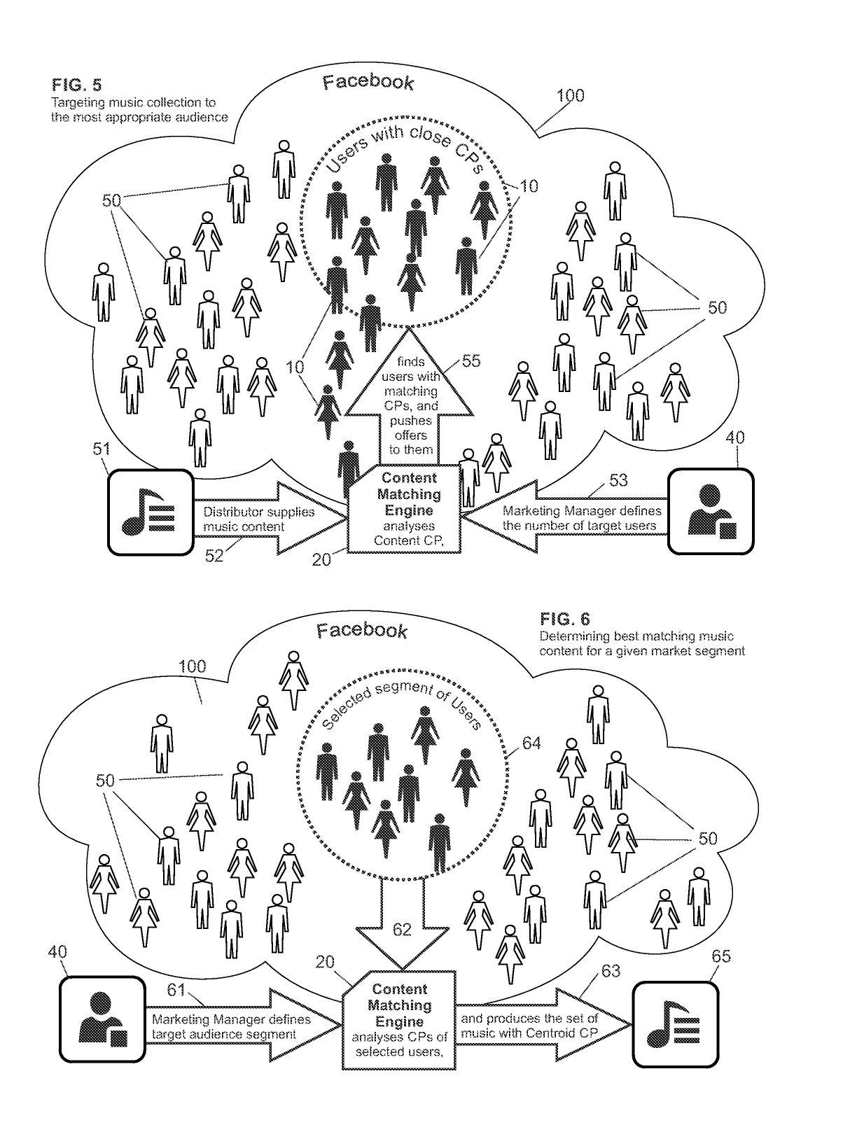

CCP ABC with, these coordinates represents an “average” preferred music for users A, B and C. It will, be shown below in FIG. 5 how this average can be used to compile a set of musical content equally suitable for a given group of users.

FIG. 3 illustrates how the users of computerized social networks are provided with the ability to find their “peers”, i.e., people with the closest culturally-related preferences. It depicts an exemplary embodiment of a Content Matching Engine (20) aimed for finding music “peers”, i.e., people with the closest music related preferences, for the user (31) of Match.com dating service network (200).

In this embodiment, Content Matching Engine (20) is installed as a part of a music streaming software program within the Facebook environment (100). For this embodiment, we assume that the Match.com users (30) have been logged in to Match.com service (200) using their Facebook identities, thus giving the Content Matching Engine (20) access rights to their Facebook profiles. For this embodiment, we also assume, that while using Facebook, these Match.com users (30) have already expressed their preferences in music by “liking” or “sharing” corresponding content items on Facebook. Using Facebook API Match.com service (200) connects to Content Matching Engine (20) directing it to collect information on the musical items “liked” by users (30). Once the users' “likes” are known, Content Matching Engine (20) calculates TRs and CPs for each user (30). In addition, it calculates distances ΔCPs from each user (30), for example user (31), to every other user (30). Let us recall that the main purpose for the use of Social Genome Model is to select from the domain of all users (30) a group of users (10) that has preferences close to those of a particular user (31). The degree of closeness is set in the administration, module (32) by an administrator of the social network or, alternatively, by the user (31) him/herself. In terms of Social Genome Model, it is expressed as a maximum distance (max ΔCP). Now Content Matching Engine 20 selects users 10 in such way that a distance between user (31) and any user in the group (10) is less than max ΔCP. The value of max ΔCP can be set from empirical considerations as a number or as a percentile of all users (30). In the former case the criterion of closeness can be formulated, for example, as “Select all users located (in SGM terms) not farther from user (31) than 0.01”. In the latter case, the criterion of closeness can be formulated, for example, as “Select no more than 5% of all users (30) that are the closest to user (31)”.

The above calculations are performed for each user (30). As a result, each user has an established group of his/her closest music “peers”. Thus, in this embodiment, the Content Matching Engine (20) pushes (33) user profiles with the matching CPs to the requesting Match.com user (31), thus allowing him/her to instantly discover his/her circle of “peers”, i.e., people with the closest match of cultural preferences.

FIG. 4 illustrates the process of delivering to the social network users precisely targeted and highly relevant recommendations regarding culture related content and products. It depicts an exemplary embodiment of a Content Matching Engine (20) configured to achieve targeted distribution of user recommendations/suggestions.

In this embodiment, Content Matching Engine (20) is deployed within the music streaming software application in Facebook environment (100). Facebook users (50) identify their musical preferences by “liking” musical content, thus creating their preferred music libraries. Content Matching Engine (20) collects information on the musical items “liked” by users (50). Once the users' “likes” are known, Content Matching Engine (20) calculates TRs and CPs for each user (50). In addition, it calculates distances ΔCPs from each user (50), for example user (41), to every other user (50). Once again, the main general purpose of the Social Genome Model is to select from the domain of all users (50) a group of users (10) having preferences close to those of a particular user (41). The degree of desired closeness is set in the administration module (42) by an administrator of the social network or, alternatively, by the user (41) him/herself. In terms of Social Genome Model, it is expressed as a maximum distance (max ΔCP). Now Content Matching Engine (20) selects users (10) in such way that a distance between user (41) and any user (10) is less than max ΔCP. The value of max ΔCP can be set from empirical considerations as a number or as a percentile of all users (50). In the former case the criterion of closeness can be formulated, for example, as “Select all users that a located (in SGM terms) not farther from user (41) than 0.01”. In the latter case, the criterion of closeness can be formulated, for example, as “Select no more than 5% of all users (50) that are the closest to user (41)”.

The above calculations are performed for each user (50). As a result, each user has an established group of his/her closest “peers”. These “peers” are targets for distribution of user (41) recommendations and suggestions. For example, user (41) new music “like” is pushed to all users (10) in a form of recommended content. Since users (10) taste and preferences are close to those of user (41), his/her recommendations will be very relevant to users (10) and will be appreciated by them. This appreciation makes a desired action on the part of users (10) more likely. For example, users (10) are more likely to listen to the music recommended by user (41), and, vice versa, user (41) is likely to appreciate music recommended by users (10).

This exemplary embodiment monitors activity of the users (50) and dynamically tracks changes in their CPs caused by new “likes”. Correspondingly, the ΔCPs are also dynamically recalculated, and the users in “peer group” (10) of each user (50) are dynamically adjusted.

FIG. 5 illustrates the process of defining the most appropriate target audience for a particular set of cultural content items. It depicts an exemplary embodiment of Content Matching Engine (20) that utilizes Social Genome Model to discover a group of Facebook users (10) out of all Facebook users (50) that are the most suitable targets for advertising and distribution of a particular musical content. This embodiment is incorporating herein the above description for FIG. 4, and we assume that CPs for all users (50) have been calculated by Content Matching Engine (20) already.

For this exemplary embodiment, let us assume that a certain music distribution company (51) is about to market some newly recorded set of musical content (for example, a new album of a band), and has certain marketing budget allotted. Marketing Manager (40) of the above-mentioned distribution company (51) intends to advertise album to Facebook users (50). In order to stay within the allocated budget, Marketing Manager (40) determines the maximum number of users (50) he/she can afford to advertise to within the given budget, and supplies (53) this maximum number N to Content Matching Engine (20). The songs in the album are tagged, so, the tagging info of the entire album is supplied (52) to Content Matching Engine (20) for calculating corresponding TRs and CP for the album. See description of FIG. 1 for calculation details. Since the album now has a CP associated with it, its CP can be logically matched against CPs of Facebook users (50).

Content Matching Engine (20) calculates ΔCPs between the album's CP and the CPs of users (50). The N smallest ΔCPs (and corresponding CPs) are then selected. The users (10) associated with these CPs represent the target audience the Marketing Manager was seeking, as they are those who will, most likely respond positively to the music content advertised to them.

FIG. 6 illustrates the process of defining the most appropriate set of cultural content items for a particular user segment of a given social network. It depicts an exemplary embodiment of Content Matching Engine (20) that, utilizes the Social Genome Model to define a content most suitable for a given audience. Descriptions for FIGS. 1, 2 and 4 are incorporated herein.

For this exemplary embodiment, let us assume that a music distribution company is compiling a set of new musical content suitable for a particular market segment, for example, German speaking Facebook (100) users of age 17 to 24. Then, the company Marketing Manager (40) selects (51) a corresponding subset (64) of users (50) of a Facebook (100).

Content Matching Engine (20) calculates CPs for all users in subset (64). See description for FIGS. 1 and 4 for details.

The Marketing Manager's goal now is to request the content management department for the set of new music albums, which will most likely meet with approval and appreciation of the users in subset (64). Note that any album consists of tagged musical items (for example, songs). Content Matching Engine (20) calculates (62) the centroid point for all CPs associated with subset (64). See description for FIG. 2 for details. For illustration purposes and extending descriptions for FIG. 1 and 2, let us postulate that the calculated centroid point of the subset (64) has the following TRs:

TR1(rock)=0.25

TR2(jazz)=0.10

TR3(classical)=0.37

TR4(pop)−0.20

TR5(country)=0.05

Interpreting the Social Genome Model terms it means that the ideal musical collection (65) for users (64) should be comprised of 25% of rock albums, 10% of jazz albums, 37% of classical albums, 20% of pop albums and 5% of country albums. The content management department of our hypothetical distribution company should now look for new records that matches the above percentages.

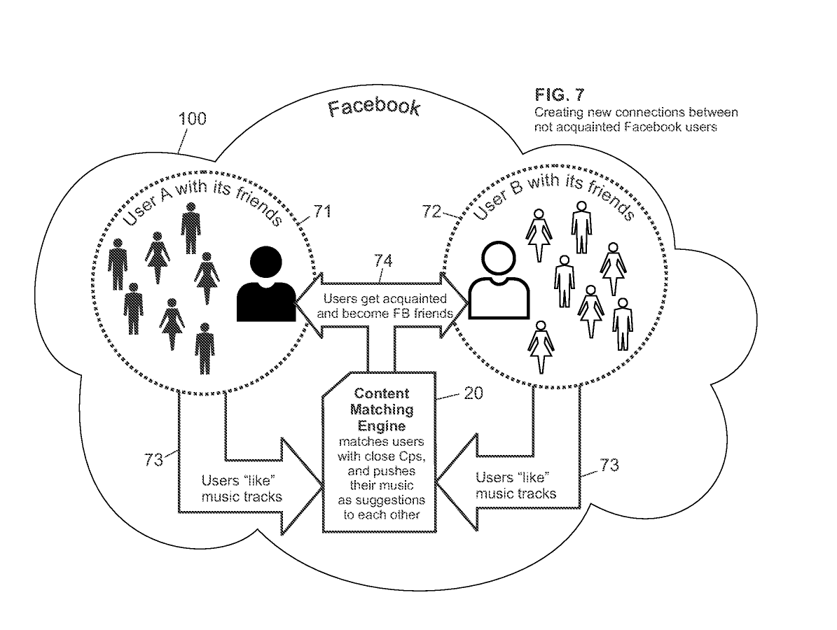

FIG. 7 illustrates the process of increasing the exposure, and thus effectiveness, of advertisements by motivating users to establish new relationships with their “peers” in the social network”. It depicts how an exemplary embodiment of Content Matching Engine (20) motivates users (50) of Facebook (100) to establish new relations with other users and to increase traffic within the network. Facebook users in a normal course of their activity form associations with other users. In Facebook terminology, they are called “Friends.” People become Friends by sending “invites” to their contacts. The contacts are derived from the user's contact lists in other popular online tools like Skype, email services and such. Facebook also suggests people under “People you may know” auspices. Facebook matches these people with a given user's profile. These matches are very often trivial (for example “a friend of a friend”) or even irrelevant. In addition, the circle of people, which any individual may know or know of is naturally limited and people are reluctant to expand it without good justification.

Content Matching Engine (20) offers a more precise way to find people that are likely to become friends, namely, people with shared Interests and preferences. Let as consider the exemplary embodiment of Content Matching Engine (20) described above in connection with FIG. 4. In this embodiment, Content Matching Engine (20) pushes music suggestions/recommendations from one person to another based on their calculated mutual affinity to the same musical content. FIG. 7 shows user A and his/her circle of Facebook friends (71) and user B with a different circle of friends (72). These circles have nobody in common. Therefore, users A and B are unlikely to ever become friends. However, both users have “liked” certain musical content. These “likes” (73) are analyzed by the exemplary embodiment of Content Matching Engine. Content Matching Engine (20) determines that CPs of users A and B are located close to one another and starts sending musical recommendations of user A to user B and vice versa. These recommendations are highly relevant to and appreciated by both user A and user B because then musical preferences are indeed similar. Thus, users A and B are motivated to invite each other to become Friends (74). Accordingly, users A and B from an association that would not have happened otherwise. Naturally, the more associations between the users exist in the social network, the more efficient it is in propagation of information, advertising and marketing in particular.

In operation, the Content Matching Engine is installed within the social network type Internet community such as Facebook, Google+, Netflix, Amazon, etc. The user of such Internet community, during his/her regular course of action expresses and stores his/her preferences regarding cultural content items such as books, music, movies, dance, ballet, theater, comedy, fine arts, etc. by, for example, “liking” a music track on Facebook, or renting a movie on Netflix, or buying a book on amazon. The Content Matching Engine monitors the user actions, calculates and updates the user's Content Point value within the community, and finds other users with the closest Content Point values. It keeps and updates the computed data constructs for the purpose of performing other “by request” operations such as discovering the most relevant group of users for the particular set of cultural content items, or for composing of the most suitable set of content items for a given target group of users submitted by the content supplier. As a result, all participants of the said Internet community such as users, cultural content suppliers, advertisers, as well as the Internet community holder itself gain the following beneficial effects:
1) Users are able to find their “peers”—people with the closest culture related preferences.
2) Users receive precisely targeted and highly relevant recommendations regarding cultural content such as books, music, movies, dance, ballet, theater, comedy, fine arts, etc., and culture related products such as fashion, jewelry, accessories, ears, tourism, recreation, etc. These recommendations are generated automatically based on content and product selections made by the user's “peers”.
3) Cultural content suppliers are able to discover the most appropriate target audience for a particular set of cultural content items.
4) Cultural content suppliers are able to define the most appropriate set of cultural content, items for a particular user or a group of users.
5) Advertisers of culture related products such as fashion, jewelry, accessories, cars, tourism, recreation, etc. increase the exposure and relevance of their ads.
6) The Internet community holder and all advertisers within the community increase the exposure, and thus effectiveness, of advertisements by motivating users to establish new relationships with their “peers” in the social network.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without, undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above described exemplary embodiments, but should, be defined only in accordance with the following claims and their equivalents.

What is claimed is:

1. A method of identifying individuals having similar preferences among users of a social network, the method comprising the steps of:
identifying a plurality of individual social network users, each of said individual users having a plurality of classifiable content items;
assigning at least one identifying characteristic to each classifiable content item;
assigning to each individual social network user a calculated identification value based on said each individual user's preferences with respect to said classifiable content items, said calculated identification value being calculated as a function of a plurality of said identifying characteristics of said individual user's content items;
calculating correlations between said calculated identification values of said plurality of individual social network users, said calculating being performed using a canonical mathematical function;
identifying individual social network users having similar preferences by identifying corresponding calculated identification values being in close correlation to one another; and
enabling communication between said individual social network users having similar preferences.

2. The method according to claim 1 further comprising the steps of dynamically recalculating said calculated identification value and said calculated correlations between said calculated identification values, and dynamically re-adjusting identification of said individual social network users having similar preferences.

3. A method of delivering a targeted communication regarding a specific content to users of a social network, the method comprising the steps of:
identifying a plurality of individual social network users, each of said individual users having a plurality of classifiable content items;
assigning at least one identifying characteristic to each classifiable content item;
assigning to each individual social network user a calculated identification value based on said each individual user's preferences with respect to said classifiable content items, said calculated identification value being calculated as a function of a plurality of said identifying characteristics of said individual user's content items;
calculating correlations between said calculated identification values of said plurality of individual social network users, said calculating being performed using a canonical mathematical function;
identifying a first and a second social network user having similar preferences by identifying corresponding first and second calculated identification values being in close correlation to one another;
preparing a targeted communication regarding said specific content directed at the first social network user; and
transmitting said targeted communication to said first social network user from said second social network user having similar preferences.

4. The method according to claim 3 further comprising the step of dynamically recalculating said calculated identification value and said calculated, correlations between said calculated identification values and dynamically re-adjusting identification of said first and second individual social network users having similar preferences.

5. A method of identifying an appropriate target audience for a particular set of cultural content items, the method comprising the steps of:
providing a plurality of individual social network users, each of said individual users having a plurality of classifiable user-content items;
assigning at least one identifying characteristic to each classifiable user-content item;
assigning to each individual social network user a first calculated identification value based on said each individual user's preferences with respect to said classifiable user-content items, said first calculated identification value being calculated as a function of a plurality of said identifying characteristics of said individual user's user-content items;
providing a separate set of classifiable entity-content items;
assigning at least one identifying characteristic to each classifiable entity-content item;
assigning to said separate set a second calculated identification value, said second calculated identification value being calculated as a function of a plurality of said identifying characteristics of said entity-content items;
calculating correlations between each of said first calculated identification values of said plurality of individual social network users and said second, calculated identification value of said separate set, said calculating being performed using a canonical mathematical function;
identifying a predetermined number of individual, social network users having first calculated identification values being in close correlation to said second calculated identification value; and
distributing said separate set of classifiable entity-content items to said identified predetermined number of individual social network users.

6. A method of defining a set of cultural content items for a particular user segment of a social network
identifying a particular user segment from a plurality of individual social network users, each of said individual users having a plurality of classifiable content items;
assigning at least one identifying characteristic to each classifiable content item;
assigning to each individual social network user from said particular user segment a calculated identification value based on said each individual user's preferences with respect to said classifiable content items, said calculated identification value being calculated, as a function of a plurality of said identifying characteristics of said individual user's content items;
determining a first centroid point for all calculated identification values of said plurality of individual social network users; and
selecting a separate set of classifiable entity-content items having a second centroid point being in close correlation to said first centroid point.

7. The method according to claim 6, further comprising a step of distributing said separate set of classifiable entity-content items to all users within said identified particular user segment.

8. The method according to claim 6, further comprising a step of delivering a commercial message regarding said separate set of classifiable entity-content items to all users within said identified particular user segment.

9. A system comprising:
a social network having a plurality of individual social network users, each of said individual users having a plurality of classifiable content items, the social network further including at least one memory component, each of said individual users storing its preferences with respect to said plurality of classifiable content items on said memory component;
a processor component connected to said social network, said processor component being configured to
a) assign at least one identifying characteristic to each classifiable content item,
b) retrieve said individual user's preferences and assign to each individual social network user a calculated identification value based on said each individual user's preferences with respect to said classifiable content items, said calculated identification value being calculated as a function of a plurality of said identifying characteristics of said individual user's content items,
c) calculate correlations between said calculated identification values of said plurality of individual social network users, said calculating being performed using a canonical mathematical function, and
d) identify individual social network users having similar preferences by identifying corresponding calculated identification values being in close correlation to one another; and
a communication component located within said social network, said communication component being configured to enable communication between said individual social network users identified by the processor component as having similar preferences.

10. A system comprising:
a social network having a plurality of individual social network users, each of said individual users having a plurality of classifiable content items, the social network further including at least one memory component, each of said individual users storing its preferences with respect to said, plurality of classifiable content items on said memory component;
a processor component connected to said social network, said processor component being configured to
a) assign at least one identifying characteristic to each classifiable content item,
b) retrieve said individual user's preferences and assign to each individual social network user a calculated identification value based on said each individual user's preferences with respect to said classifiable content items, said calculated identification value being calculated as a function of a plurality of said identifying characteristics of said individual user's content items,
c) calculate correlations between said calculated identification values of said plurality of individual social network users, said calculating being performed using a canonical mathematical function, and
d) identity a first and a second social network, user having similar preferences by identifying corresponding first and second calculated identification values being in close correlation to one another; and
a communication component being configured to prepare a targeted communication regarding a specific content, directed at the first social network user, and to transmit said targeted communication to said first social network user from said second social network user having similar preferences.

11. A system comprising:
a social network having a plurality of individual social network users, each of said individual users having a plurality of classifiable content items, the social network further including at least one memory component, each of said individual users storing its preferences with respect to said plurality of classifiable content items on said memory component; and
a processor component connected to said social network, said processor component being configured to
a) assign at least one identifying characteristic to each classifiable content item,
b) retrieve said individual user's preferences and assign to each individual social network user a first calculated identification value based on said each individual user's preferences with respect to said classifiable content items, said first, calculated identification value being calculated as a function of a plurality of said identifying characteristics of said individual user's content items.
c) receive data corresponding to a separate set of classifiable entity-content items,
d) assign at least one identifying characteristic to each classifiable entity-content item,
e) assign to said separate set a second calculated identification value, said second calculated identification value being calculated as a function of a plurality of said identifying characteristics of said entity-eon tent items,
f) calculate correlations between each of said first calculated identification values of said, plurality of individual social network users and said second calculated identification value of said separate set, said calculating being performed using a canonical mathematical function, and
g) identify a predetermined number of individual social network users having first calculated identification, values being in close correlation to said second calculated identification value; and
a distribution component located on said social network and configured to distribute said separate set of classifiable entity-content items to said identified predetermined number of individual social network risers.

12. A system comprising:
a social network having a plurality of individual social network users, each of said individual users having a plurality of classifiable content items, the social network further including at least one memory component, each of said individual users storing its personal data and preferences with respect to said, plurality of classifiable content items on said memory component; and
a processor component connected to said social network, said processor component being configured to
a) retrieve said personal data from said memory component and identify a particular user segment from a plurality of individual social network users based on said personal data,
b) assign at least one identifying characteristic to each classifiable content item,
c) retrieve said individual user's preferences and assign to each individual social network user from said particular user segment a calculated identification value based on said each individual user's preferences with respect to said classifiable content items, said calculated identification value being calculated as a function of a plurality of said identifying characteristics of said individual user's content items,
d) determine a first centroid point for all calculated identification values of said plurality of individual social network users, and
e) select a separate set of classifiable entity-content items having a second centroid point being in close correlation to said first centroid point.
